(19) United States
(12) Patent Application Publication
(10) Pub. No.: US 2011/0042536 A1
(43) Pub. Date: Feb. 24, 2011

(54) Selectively Positionable Device for Securing an Instrument

(75) Inventors: Mark Phillips, Thornton, CO (US); Craig Norman, Longmont, CO (US)

Correspondence Address: SHERIDAN ROSS PC, 1560 BROADWAY, SUITE 1200, DENVER, CO, 80202, US

(73) Assignee: Thule Organization Solutions, Inc., Longmont, CO (US)

(21) Appl. No.: 12/859,636

(22) Filed: Aug. 19, 2010

Related U.S. Application Data
(60) Provisional application No. 61/235,247, filed on Aug. 19, 2009.

(51) Int. Cl. F16M 13/00

(52) U.S. Cl. 248/299.1

(57) ABSTRACT

A device for securing an instrument is provided that includes at least one flexible, bendable leg with a grippable surface. In one embodiment, the flexible and bendable legs comprise core with an over-wrapped sheath. The contemplated device may be bended, twisted, or otherwise manipulated to selectively secure the device to objects having various shapes and sizes. The flexible and bendable legs increase the versatility and overall securability of the device.

This application claims the benefit of U.S. Provisional Patent Application Ser. No. 61/235,247, filed Aug. 19, 2009, the entire disclosure of which is incorporated by reference herein.

### FIELD OF THE INVENTION

The present invention is generally related to a selectively positionable device for supporting an electrical device, for example. More specifically, embodiments of the present invention include at least one flexible, bendable leg having a grippable surface such that the device may be configured as a tripod, a bipod or a monopod.

### BACKGROUND OF THE INVENTION

Typically, tripods include three rigid or semi-rigid legs and a head for mounting an instrument, such as a telescope, a camera, an optical/recording instrument, a GPS device, or other similar devices (hereinafter “instrument”). Tripods are traditionally positioned on substantially stable, horizontal surfaces, such as the ground or a table. Conventional tripods are unable to secure on to unstable and irregularly shaped objects, such as a chair, a tree, a light post, a railing or a fence.

Thus, it has been a long felt need to provide a device for securing an instrument that is adjustable, securable and easy to use.

### SUMMARY OF THE INVENTION

It is one aspect of the present invention to provide a selectively positionable device for securing an instrument. More specifically, the device of one embodiment of the present invention includes at least one selectively positionable leg such that the device may be configured as a tripod, a bipod or a monopod. The legs of one embodiment of the present invention are capable of being twisted and secured to objects of various size and shape. The legs of one embodiment are flexible and bendable to increase the adjustability and maneuverability of the device. In addition, the legs preferably provide a grippable surface so that the device can be selectively secured to objects having different shapes and sizes. In one embodiment of the present invention, the legs preferably include a flexible metal core surrounded by a foam sheath. One of skill in the art will appreciate that other flexible members may be used, such as interlinked members as disclosed in, for example, U.S. Pat. No. 6,408,524 to Lai, U.S. Patent Application Publication No. 2007/0212163 to Bevrit, U.S. Patent Application Publication No. 2007/0154254 to Bevrit, and U.S. Patent Application Publication No. 2005/0082824 to Luettgen et al. The foam sheath may include a rubber or plastic surface that may also be textured to prevent slippage. Further, the device of one embodiment of the present invention is lightweight, easy to use, and inexpensive to manufacture.

It is another aspect of the present invention to provide a device having a head or attachment member that receives a variety of different instruments or devices, such as a camera, spotting scope, video camera, etc. The head of one embodiment of the present invention is capable of rotating, tilting, and swiveling to increase the versatility and adjustability of the device. In one embodiment of the present invention, the head preferably includes a ball socket that interconnects an upper portion of the legs.

The Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description given below, serve to explain the principles of these inventions.

FIG. 1 is a perspective view of the device of one embodiment of the present invention, shown in a tripod configuration;

FIGS. 2-4 are photographic views of the device of one embodiment of the present invention, shown in a monopod configuration and positioned on or around various objects; and

FIG. 5 is a partial view of a leg of one embodiment of the present invention.

To assist the understanding of one embodiment of the present invention the following list of components and associated numbering found in the drawings is provided herein:

| # | Component |
|---|---|
| 2 | Device |
| 6 | Leg |
| 10 | Core |
| 14 | Sheath |
| 18 | Top portion |
| 22 | Bottom portion |
| 26 | End cap |
| 30 | Head |
| 32 | Instrument |
| 34 | Extension member |
| 38 | Mount |
| 42 | Mounting screw |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

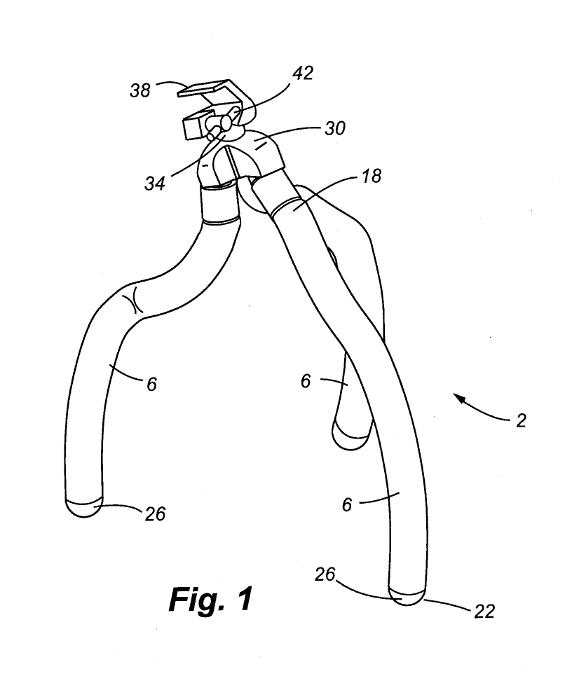

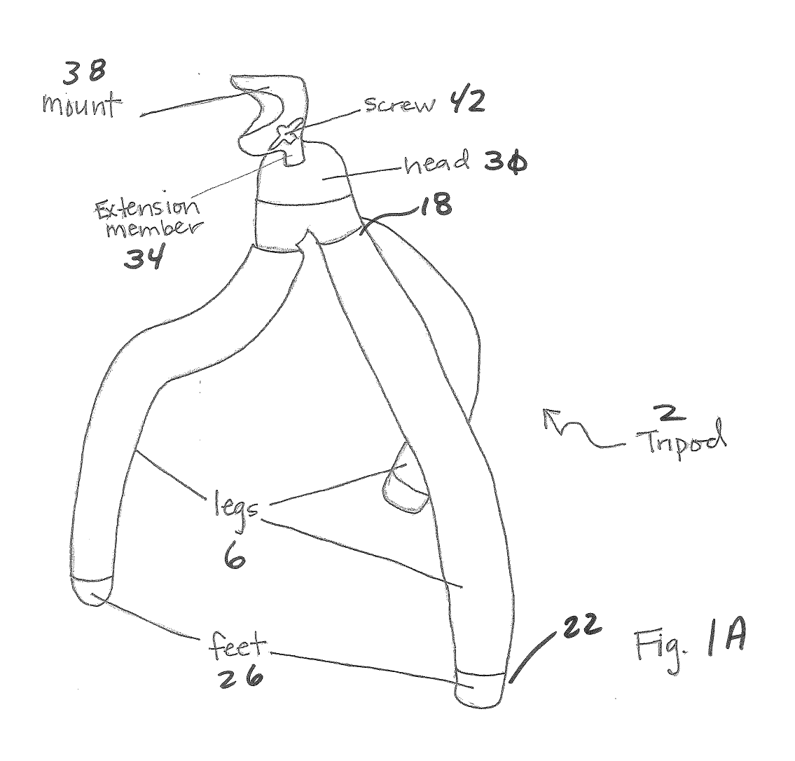

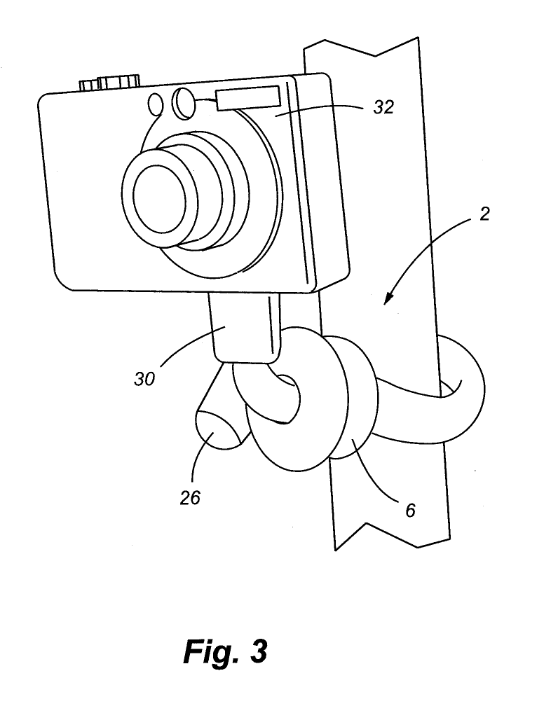

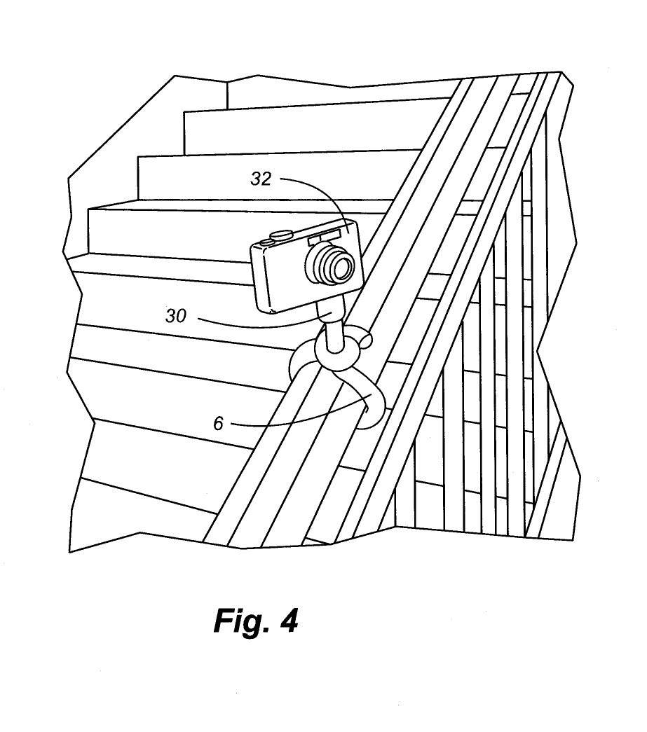

Referring now to FIGS. 1-4, devices having flexible, bendable, and grippable legs 6 of one embodiment of the present invention are shown. One skilled in the art will appreciate that the device 2 of the present invention may be used in many fields and for a broad range of applications requiring or desiring a stable support surface, such as, photography, film, astronomy, surveying, surveillance, hunting, etc.

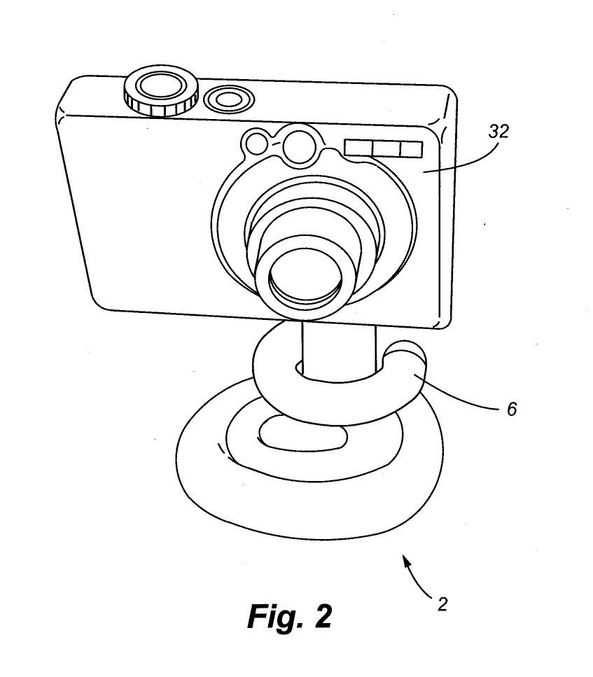

FIG. 1 shows the device 2 of one embodiment of the present invention in a tripod configuration. FIGS. 2-4 show the device 2 of another embodiment of the present invention that is used as a monopod. The device 2 includes at least one selectively positionable leg 6. In one embodiment, the device 2 includes three selectively positionable legs. One of skill in the art will appreciate that the device may be configured to have any number of selectively positionable legs and the invention is not limited to any specific configuration of legs. The legs 6 are of sufficient length so that they can be twisted around objects of various sizes. The legs preferably possess flexibility so that the device may be folded into a compact, unobtrusive and easy-to-store configuration.

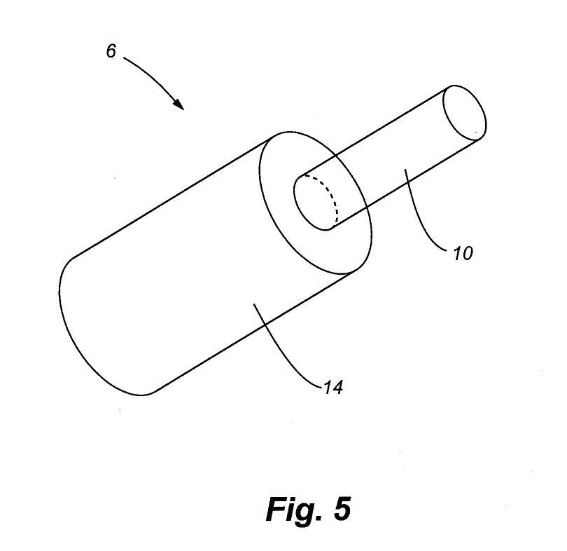

Referring now to FIG. 5, in one embodiment, the device legs are elongated, flexible and bendable. The diameter of the leg 6 is preferably narrow enough to be wrapped around objects of variable size, such as a small tree, railing, or light pole. The diameter of the leg is also preferably wide enough to be easily manipulated by a user's hand. One of skill in the art will appreciate that each of the legs 6 of the device may have the same diameter or they may also have different diameters.

Moreover, the device's legs are preferably flexible and bendable and capable of being bent in a multitude of directions. In one embodiment, the legs 6 comprise a core 10 that is at least partially wrapped by a sheath 14. More particularly, the core 10 is a strong yet flexible material that is capable of retaining its shape when bent, such as a flexible wire. One of skill in the art will appreciate that the core material may be made of any suitable elongated flexible metal wire or cable, and the rigidity and bendability of the leg will depend significantly on the type of metal material used, as well as the thickness. As mentioned above, other devices, such as those comprised of interlocked members may be used to provide the required flexibility. One skilled in the art will appreciate that the degree of interlock between each member may be varied to increase or decrease the flexibility of the leg. In one embodiment, the metallic wire material has a thickness of between about ⅛ inch and 1 inch thick. The sheath 14 is a flexible and pliable material, such as a foam rubber, that is capable of being manipulated into different shapes. In a preferred embodiment, the sheath 14 is a foam rubber having a non-slip or slip-resistant exterior. The non-slip surface is desirable so that once positioned, the device will stay securely and firmly in place. A non-slip surface is especially advantageous when securing the device to a vertical object. For example, the device can be securely positioned on a tree, light pole, bicycle handle bars, or vertical object and because of the non-slip exterior, the device will not slide/slip down. One of skill in the art will appreciate that the device may include any number of non-slip or slip-resistant materials, such as rubber, plastic, or texturized material.

The foam rubber also protects the object to which the device is secured. For example, the device can be secured to a railing and the foam rubber legs will protect the railing from being scratched, nicked or otherwise damaged. Alternatively, the device can be used as a traditional tripod. For example, the device may be positioned and used on a table without securing the device to the table. Additionally, the device of one embodiment of the present invention is environmentally friendly in that the device's bendable and grippable legs may be secured to a living organism, such as a plant or tree, while not damaging or only minimally damaging the organism, its ecosystem, and the environment.

The foam rubber also provides an easily grippable surface. A device having legs with an easily grippable surface is desirable because it facilitates quick and easy engagement and disengagement. Moreover, an easily grippable/graspable surface makes this device easily usable by persons having limited dexterity. One of skill in the art will appreciate that the device may include any number of other grippable features, such as ergonomic finger grips or grip tape.

In addition to being non-slip and grippable, the exterior of the device's legs may be treated with a waterproof or other weatherproof coating. One of skill in the art will appreciate that a device having legs that are waterproof/weatherproof facilitates the devices usefulness in outdoor settings. It is envisioned that the device of the present invention could be used with a waterproof camera for water activities, such as boating, fishing, and kayaking. For example, a waterproof camera may be mounted to the device and the waterproof legs may be wrapped around a boat's mast or other structure and the user would have a stable and secure way to take pictures on the boat. Moreover, the grippable exterior of the device's legs would help the device remain securely positioned, even when wet.

For some applications, it may be desirable to attach the device to an object that is difficult and/or impossible to wrap the flexible and bendable legs around. Thus, in some embodiments of the present invention, the device includes at least one suction cup adapted to attach the device to an object, such as a glass door, window, or table.

In still further embodiments of the present invention, the exterior of the device may also include a camouflaging material or camouflaged exterior. One of skill in the art will appreciate that a device having camouflaging qualities is advantageous for many fields requiring or desiring that the device be concealed or undetected, such as hunting and surveillance.

In another embodiment of the present invention, the exterior of the device's legs may include more than one textured material. For example, in one embodiment of the present invention, the exterior of the device's legs may have a first textured material and a second textured material having cut-outs or finger grips. The dual-texture exterior provides enhanced grippability for the user. One of skill in the art will appreciate that the exterior of the device's legs may include any number of textured materials to increase the grippability and graspability of the device's legs.

In other embodiments of the present invention, a device leg may optionally include a third, vibration or shock absorbing material so that less vibration is transferred to a camera or other instrument mounted to the device. One of skill in the art will appreciate that any number of anti-vibration or shock absorbing materials may be incorporated into the device's legs, such as a silicone gel pad or Sorbothane sheet. A device capable of absorbing vibrations is desirable for many applications. For example, the device having vibration absorbing material of the present invention may be mounted to an off-road or all-terrain vehicle so that a user can achieve a higher picture/film quality while shooting/filming on rough or unsteady terrain.

Referring again to FIGS. 1-4, each device leg 6 has a top portion 18 and a bottom portion 22. The bottom portion 22 of the leg 6 may be interconnected to an end cap 26. One of skill in the art will appreciate that the end caps 26 can be made of any material having anti-skid, anti-slip, or other traction enhancing properties. The end caps 26 are preferably made of a rubberized, plastic, or treaded material. In other embodiments, the end caps 26 may have additional features, such as attachable or retractable spiked end caps for securing the device to the ground. In another embodiment of the present invention, the device's legs 6 are extendable or may include rigid, telescoping legs. More specifically, in some embodiments, a leg 6 includes a leg extender that is integrated into the leg or that is attached to the leg. In still further embodiments of the present invention, the end cap 26 may include a suction cup to selectively secure the device via suction to an object, such as glass. In a preferred embodiment, the end cap 26 is configured as a ball or other spherical object.

The top portion 18 of the legs 6 are interconnected to at least one head 30 that receives and secures an instrument 32. However, one of skill in the art will appreciate that the device may be configured to have any number of heads or other interconnection mechanisms depending on the number of instruments to be secured to the device. The head 30 may be made out of any number of materials, such as plastic, metal, or other similar material.

In one embodiment, the head 30 includes at least one ball socket. The ball socket is configured to receive the top portion 18 of a leg. One of skill in the art will appreciate that the top portion 18 are selectively interconnected to the head with ball joints, pivot joints, swivel joints, or other rotatable connection. The ball joints allow the head 30 to achieve a wide range of tilt angles and positions. As such, the head 30 may be tilted in an upward or downward direction. In addition, the ball joints allow the legs to rotate in 360 degrees. Thus, the ball joints provide a wide range of motion and consequently provide a versatile device 2 that is capable of being adjusted and secured to countless objects. The head 30 may be interconnected to the legs 6 by glue, a bracket, a compression fit, etc., depending on the application, and the invention is not limited to any specific attachment device.

The head 30 of one embodiment is interconnected to a rotatable and extendable extension member 34. The extension member 34 is capable of moving through a range of motion. One skilled in the art will appreciate that the extension member 34 may be interconnected to the head 30 by any rotatable connection, or alternatively by a bracket or other assembly having multiple positions of use. In the embodiment shown, the extension member 34 is capable of rotating 360 degrees. The extension member 34 is preferably short enough so that the device remains compact and unobtrusive. However, in another embodiment, the extension member 34 may be long enough to further increase the device's versatility by allowing the instrument 32 to be mounted at some distance away from the head 30 of the device. It is further envisioned that the extension member 34 may be telescoping.

The extension member 34 of some embodiments is interconnected to a mount 38. The mount may be directly interconnected to the head 30 or it may be selectively detachable or movable from the head 30. The mount 38 secures the instrument or other object to the device. One skilled in the art will appreciate that the mount 30 may also include a mounting screw 42 or other mechanical fastening device, such as a bolt, clamp, or pin. The mounting screw 42 may also have an arm protruding therefrom for increasing the amount of torque that may be applied the screw and for providing a fastening device that is easy to operate and manipulate. The mount 38 may be configured as a plate, a clamp, snap-fit or other interface configured for attaching an object to the device 2. The mount 38 may be selectively interconnected to an instrument, such as a camera, video camera, telescope, binoculars, theodolites, firearms, or other object to be secured to and supported by the device 2.

While various embodiments of the present invention have been described in detail, it is apparent that modifications and alterations of those embodiments will occur to those skilled in the art. Moreover, references made herein to “the present invention” or aspects thereof should be understood to mean certain embodiments of the present invention and should not necessarily be construed as limiting all embodiments to a particular description. However, it is to be expressly understood that such modifications and alterations are within the scope and spirit of the present invention, as set forth in the following claims.

What is claimed is:

1. A device, comprising:
at least one flexible and bendable leg, comprising:
a first flexible and bendable core material; and
a second sheath material which substantially encloses said first core material;
at least one head interconnected to said at least one flexible and bendable leg;
a rotatable extension member interconnected to said head;
at least one mount interconnected to said rotatable extension member which is adapted to receive an instrument;
wherein said at least one leg is adapted to wrap around an object, and wherein said at least one leg is adapted to support said instrument when mounted to said device.

2. The device of claim 1, wherein said first core material is a flexible metallic wire and wherein said second sheath material is a foam rubber.

3. The device of claim 1, wherein said second sheath material comprises at least one of a foam rubber, a plastic, a nylon, or a combination thereof.

4. The device of claim 1, further comprising at least one of a second or a third flexible and bendable leg.

5. The device of claim 1, further comprising a coating material on said second sheath material.
